(19) United States
(12) Patent Application Publication
(10) Pub. No.: US 2004/0186854 A1
(43) Pub. Date: Sep. 23, 2004

(54) Method and system for managing media file database

(75) Inventor: Myoung-soon Choi, Suwon-si (JP)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/764,510

(22) Filed: Jan. 27, 2004

(30) Foreign Application Priority Data
Jan. 28, 2003 (KR) 10-2003-0005500

(51) Int. Cl. G06F 17/00

(52) U.S. Cl. 707/104.1

(57) ABSTRACT

Disclosed herein are a method and a system for managing a media file database (DB). A method of managing a media file database (DB) includes the steps of (1) searching for media files, (2) creating file directories by types, based on metadata of the searched media files, and (3) creating link files for the searched media files in the created file directories. A system for managing a media file DB comprises a search means for searching for media files, a storage means for storing the searched media files and metadata of these media files, a control means for creating file directories by types, based on the metadata of the searched media files, a copying means for copying the searched media files in the created file directories, and a display means for displaying the copied media files and the directories including the copied media files.

### BACKGROUND OF THE INVENTION

This application claims the priority of Korean Patent Application No. 10-2003-0005500, filed on Jan. 28, 2003, in the Korean Intellectual Property Office, the disclosure of which is incorporated herein by reference.

1. Field of the Invention

Methods and systems consistent with the present invention generally relate to managing a media file database, and more particularly, to a method and a system for managing a media file database in which the system is constructed with a folder and a link file in the same form of a construction of a media file management program, in a sub-structure of a folder position designated to allow a user to more easily manage classified contents of the media files, thereby being capable of managing or playing the media files.

2. Description of the Related Art

Technologies for effectively linking respective media files to manage the media files are disclosed in Korean Unexamined Patent Publication No. 10-2001-0020896 and Japanese Unexamined Patent Publication No. 2000-99341. The Korean Unexamined Patent Publication No. 2001-0020896 discloses a method in which a tree structure ranging from the uppermost node thereof to the virtual root node of a newly created lower tree window is displayed on a cascaded-window screen, with visual links being added to the tree structure. Additionally, Korean Unexamined Patent Publication No. 2001-0019444, Japanese Unexamined Patent Publication 1998-283235, U.S. Pat. No. 6,356,971 and European Patent No. 1253529 disclose programs that are each provided with a basic function in MICROSOFT WINDOWS EXPLORER and additional functions through the use of a separate media file management tool. Among the above-described patent publications, Korean Unexamined Patent Publication No. 2001-0019444 discloses a database (DB) management tool that is constructed to be operated in an environment similar to that of WINDOWS EXPLORER so as to allow users to easily find and manage the directory position or title of a desired music. However, in the above-described patent publications, the designated folder and link files of media files are not physically generated.

FIG. 1 is a view showing an execution of a conventional art media file management program by way of example, which illustrates MEDIA LIBRARY that is a conventional file management program of the MICROSOFT WINDOWS MEDIA PLAYER in common use. In the left window of FIG. 1, like WINDOWS EXPLORER, directories such as ‘AUDIO’, ‘VIDEO’, ‘MY PLAY LIST’, and the like, are arranged under an uppermost ‘MEDIA LIBRARY’ directory, ‘ALL AUDIO’, ‘ALBUM’, ‘MUSICIAN’, and ‘GENRE’ directories are arranged under the ‘AUDIO’ directory, and lowermost directories such as ‘Classical’, ‘Ballad’, ‘Other’, ‘Pop’, ‘R&B’, ‘Rock’, and ‘Vocal’ are arranged under the ‘GENRE’ directory. In the right window of FIG. 1, media files within the ‘Classical’ directory are displayed.

In general, the conventional media file management program, such as the MEDIA LIBRARY of WINDOWS MEDIA PLAYER, records and manages position path information of media files. However, the conventional media file management program is inconvenient in that users find and/or execute corresponding files in WINDOWS EXPLORER after loading an application (e.g., WINDOWS MEDIA PLAYER) and searches for media files while executing a media file management program inside the application whenever they desire to view position path information of the managed media files or play the media files. That is, such a conventional media file management program is utilized only for management inside an application such as WINDOWS MEDIA PLAYER. For this reason, the conventional media file management program is inconvenient because a corresponding application must be executed so as to ascertain the positions of managed media files.

Additionally, since most users widely utilize WINDOWS EXPLORER, this may cause a problem to the users who are unfamiliar with the media file management method inherent in programs, such as MEDIA LIBRARY, that does not support a directory management function.

### SUMMARY OF THE INVENTION

Accordingly, the present invention has been conceived to solve the problems described above, and an aspect of the present invention is to provide a method and a system for managing a media file database (hereinafter referred to as “DB”), in which the system is constructed with a folder and a link file in the same form of a construction of a media file management program, in a sub-structure of a folder position designated to allow a user to more easily manage classified contents of the media files, thereby being capable of managing or playing the media files.

Another aspect of the present invention is to provide a method and a system for managing a media file DB, in which actual files other than link files are copied into the file directories under a designated folder for various purposes, such as the copying of media files to an outside destination, so the media files can be easily managed and played.

In order to accomplish the above aspect, the present invention provides a method of managing a media file database (DB) comprising the steps of (1) searching for media files, (2) creating file directories by types, based on metadata of the searched media files, and (3) creating link files for the searched media files in the created file directories.

In addition, the present invention provides a method of managing a media file DB comprising the steps of (1) searching for media files, (2) creating file directories by types based on metadata of the searched media files, and (3) copying the searched media files to the created file directories.

In addition, the present invention provides a system for managing a media file DB comprising a search means for searching for media files, a storage means for storing the searched media files and metadata of these media files, a control means for creating file directories by types, based on the metadata of the searched media files, a copying means for copying the searched media files in the created file directories, and a display means for displaying the copied media files and the directories comprised of the media files.

### BRIEF DESCRIPTION OF THE DRAWINGS

The above and other aspects, features and advantages of the present invention will be more clearly understood from the following detailed description taken in conjunction with the accompanying drawings, in which:

FIG. 1 is a view showing an execution of a conventional media file management program by way of example;

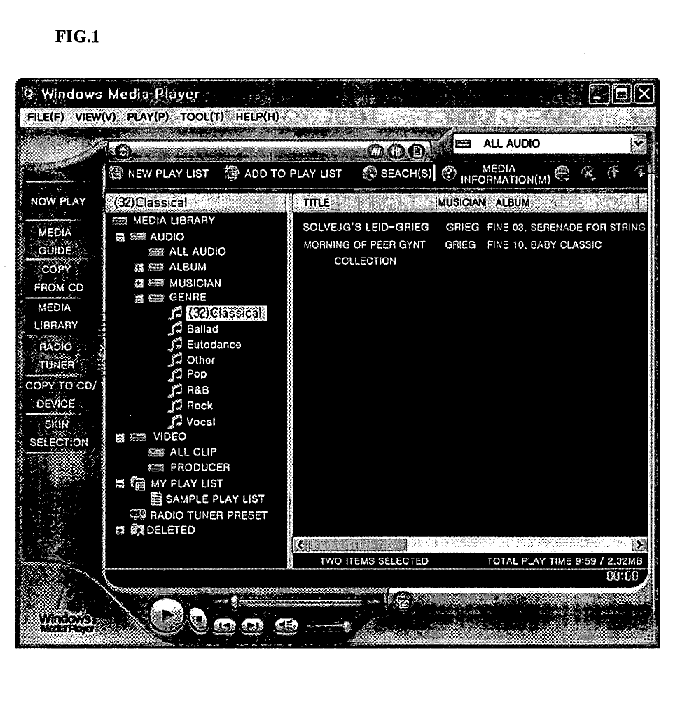

FIG. 2 is a flowchart of a management method of a media file DB in accordance with a first embodiment of the present invention;

FIG. 3 is a flowchart of a management method of a media file DB in accordance with a second embodiment of the present invention;

FIG. 4 is a block diagram of a management system of a media file DB;

FIG. 5 is a view showing an execution of the management method of the media file DB according to the first and second embodiments of the present invention;

FIG. 6 is a view showing a process of editing file directories created according to the present invention; and

FIG. 7 is a view showing a directory structure of media files created by the method for managing media file DB according to the present invention.

### DESCRIPTION OF THE EXEMPLARY EMBODIMENTS

Hereinafter, a system and a method for AV stream data copy protection according to exemplary embodiments of the present invention will be described in detail with reference to the accompanying drawings.

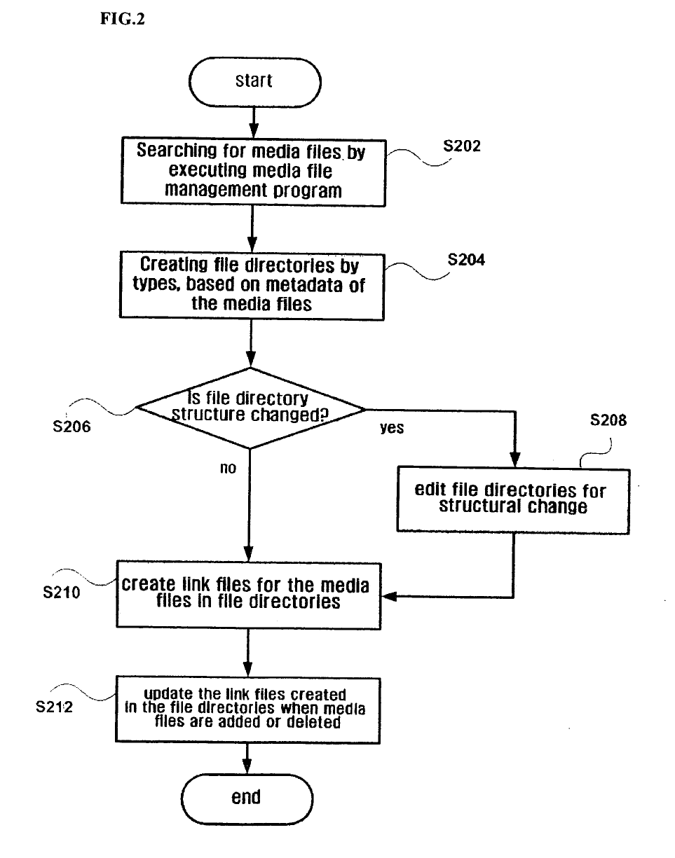

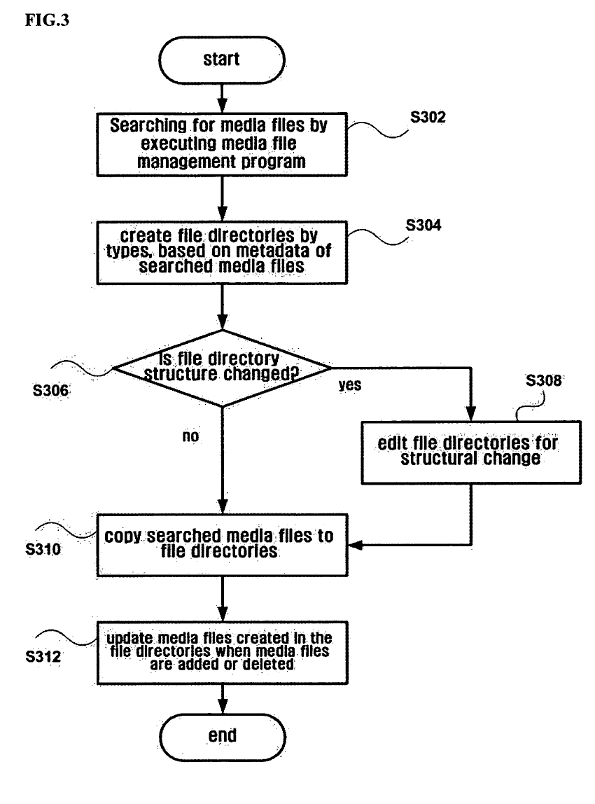

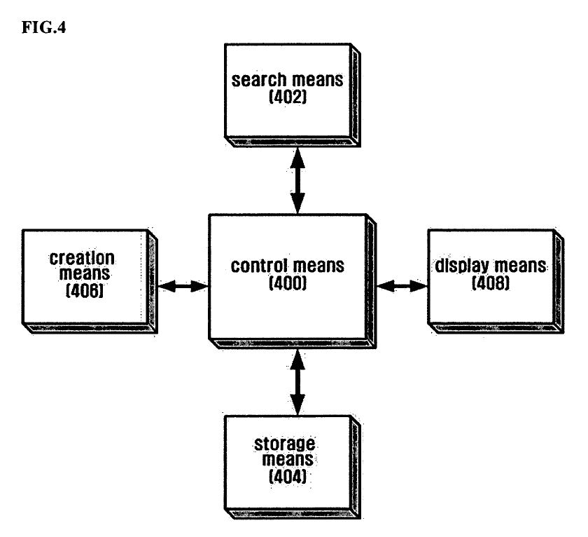

FIG. 2 is a flowchart of a management method of a media file DB in accordance with a first embodiment of the present invention. FIG. 3 is a flowchart of a management method of a media file DB in accordance with a second embodiment of the present invention. FIG. 4 is a block diagram of a management system of a media file DB.

Referring to FIG. 4, the media file DB managing system of the present invention includes a search means 402 for searching for media files, a storage means 404 for storing the searched media files and the metadata of these media files, a control means 400 for creating file directories by types based on the metadata of the searched media files, a creation means 406 for creating link files with respect to the searched media files in the created file directories, and a display means 408 for displaying the created link files and the directories comprised of the link files.

With reference to FIGS. 2, 3 and 4, the DB management methods of the first and second embodiments are described hereinafter. First, in order to obtain information on the types and position paths of media files that a user desires to manage, these media files are searched for (S202 and S302). This function is performed by the search means 402 under the control of the control means 400. Since media files having a relatively small capacity, such as Moving Picture Experts Group (MPEG)-1 Audio Layer-3 (MP3) files, may have positions different from those of other media files, a DB for media files can be constructed to search for media files by executing a media file program through the use of the search means 402 rather than by allowing the media files to be searched for by the user himself. Further, the search means 402 may search for media files within a range for search set by the user or a range for search automatically set by the media file management program. These searched media files and the metadata of the searched media files are stored in the storage means 404 by the control means 400.

Thereafter, the control means 400 creates file directories based on the metadata of the searched media files stored in the storage means 404 (S204 and S304). Of course, the control means 400 can have a control function to allow the file directories to be created in a separate storage media. Here, the separate storage media refer to all kinds of media capable of storing therein media files, comprising a compact disk (CD), a digital versatile disk (DVD), flash memory, and so on, regardless of the names thereof.

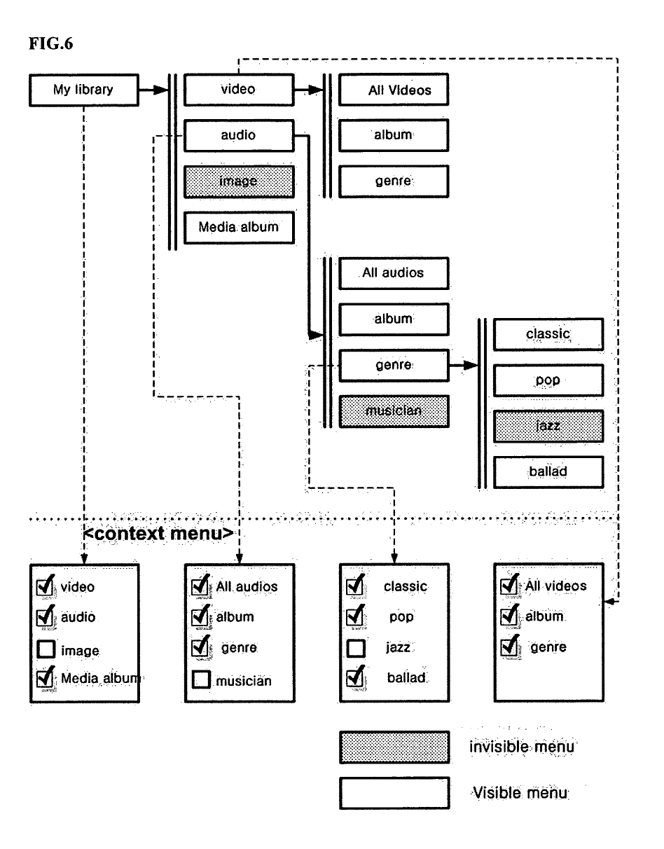

The metadata of a media file refers to data representing a definition or description of the media file, and denotes tag information, such as an actual path, file name, file type, musician, album, genre and track number of a searched media file. The creation of the file directory is performed by the control means 400. The user can set criteria from the metadata, and create file directories based on metadata corresponding to the criteria. For example, the names of the directories shown in FIG. 6 may be such criteria.

After the file directories are created, the user determines whether the tree structure of the created file directories is altered (S206 and S306). In this case when the tree structure is altered, the user may edit and alter the tree structure of the file directories using the control means 400 according to his selection S208 and S308.

FIG. 6 is a view showing a process of editing file directories created according to the present invention. If ‘video’, ‘audio’ and ‘media album’ are checked by a check mark and ‘image’ is not checked in the context menu of the uppermost directory, ‘my library’, the three checked directories are created and the ‘image’ directory is not created in a level lower than that of the uppermost directory. Thereafter, if ‘all videos’, ‘album’ and ‘genre’ are checked, three directories are created. Meanwhile, if ‘all audios’, ‘album’ and ‘genre’ of the context menu of the ‘audio’ directory created under the uppermost directory, ‘my library’, are checked and ‘musician’ is not checked, only three remaining directories except for the ‘musician’ directory are created. Additionally, if ‘classic’, ‘pop’ and ‘ballad’ of the context menu of the ‘genre’ directory, except for ‘jazz’, are checked, only the remaining ‘classic’, ‘pop’ and ‘ballad’ directories, except for the ‘jazz’ directory, are created.

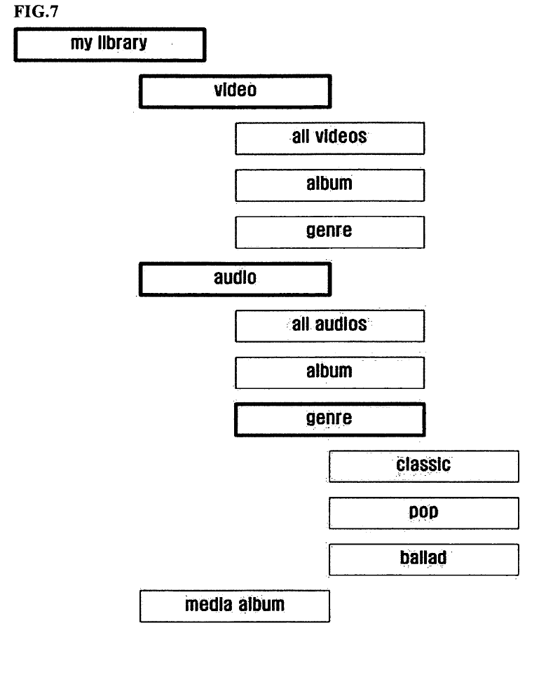

Link files for the searched media files are created in file directories that are created through the editing process or on a default basis (S210). That is, step S210 is performed by the creation means 406 under the control of the control means 400 in the first embodiment. The results in which the link files and the file directories comprised of the link files are created through the above-described editing process are shown in FIG. 7.

FIG. 7 is a view showing a directory structure of media files created by the method for managing media file DB according an exemplary embodiment to the present invention. Referring to FIG. 7, there is shown the tree structure of the file directories created through the editing process illustrated in FIG. 6. The file directories shown in FIG. 7 have a hierarchical structure and the hierarchical structure is identical to the structure of the popular WINDOWS EXPLORER, so the file directories are managed under a folder of the WINDOWS EXPLORER in the same manner as the folders of WINDOWS EXPLORER.

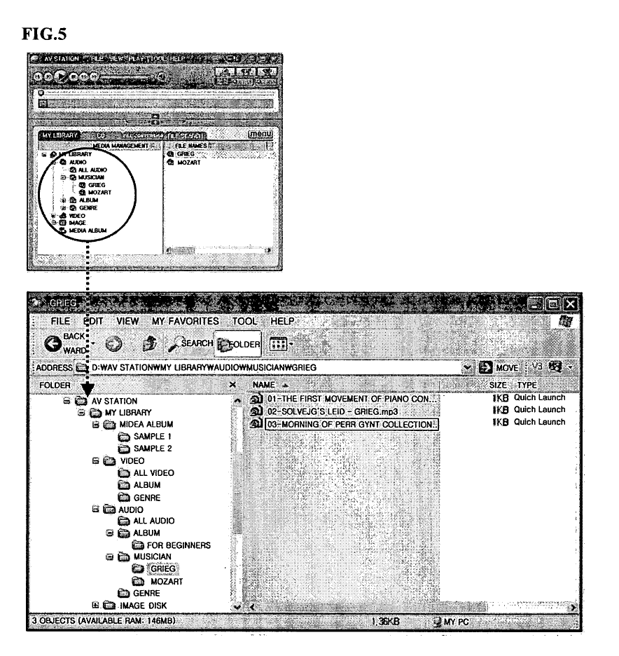

The above-described management method is depicted in FIG. 5. FIG. 5 is a view showing an execution of the management method of the media file DB according to the first and second embodiments of the present invention. The upper window of FIG. 5 shows the WINDOWS MEDIA PLAYER application, and the lower window of FIG. 5 is an example illustrating how the link files of media files created according to the present invention and the directories comprised of the link files are managed within WINDOWS EXPLORER. This function is performed by the display means 408 under the control of the control means 400. The left portion of the lower window of FIG. 5 shows the state where the ‘Grieg’ directory under the ‘musician’ directory under the ‘audio’ directory under the ‘my library’ directory under the ‘AV station’ directory is selected, and the right portion of the lower window of FIG. 5 illustrates that three MP3 files under the ‘Grieg’ directory are shown.

In the second embodiment of the present invention, media files and directories comprised of the media files are created by copying actual media files, not link files, to the created file directories (S310), instead of creating link files of the media files in the created file directories as in the first embodiment. Additionally, the actual media files, not link files, can be copied to the file directories created in a separate storage media (referring to all types of media capable of storing therein media files, such as a CD and a DVD, etc.).

After step S210 (for the first embodiment) or step S310 (for the second embodiment), the user may add new media files to the directories or delete media files from the directories while continuously managing the media files. That is, the control means 400 updates the link files or the copied media files and the directories when media files are added or deleted at steps S212 and S312. The control means 400 is operated to perform the update function, and the update function may be performed as set by the user or automatically at a regular interval of time.

As described above, the user creates file directories based on the metadata of searched media files and creates link files in the created file directories, so media files can be easily managed and played through WINDOWS EXPLORER or any other similar programs. Actual files other than link files are copied into the file directories for the reason of copying media files to a separate storage media.

As described above, the present invention provides a method and a system for managing a media file DB, in which the classification information of media files is arranged under a designated folder in a tree structure, made up of link files and directories consisting of the link files, identical to that of a media file management program to provide users with easy access to the media files, so the media files can be easily managed and played even when using a program such as WINDOWS EXPLORER. Meanwhile, actual files other than link files may be copied to the file directories under the designated folder for the reason of copying media files to a separate storage media.

Additionally, users can edit file directories according to input information, and update the files of the file directories when some files are added and deleted, thus easily managing the file directories and the media files.

While the invention has been described above with respect to WINDOWS EXPLORER and WINDOWS MEDIA PLAYER, the application of the invention is not limited to WINDOWS EXPLORER and WINDOWS MEDIA PLAYER, but can be applied with respect to other programs similar to WINDOWS EXPLORER and WINDOWS MEDIA PLAYER.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of managing a media file database (DB), comprising:
searching for media files;
creating file directories based on metadata of the media files; and
creating link files for the media files in the file directories.

2. A method of managing a media file database (DB), comprising:
searching for media files;
creating file directories based on metadata of the media files; and
copying the media files to the file directories as copied media files.

3. The method as claimed in claim 1 or 2, wherein the searching for the media files comprises executing a media file management program.

4. The method as claimed in claim 3, wherein in the searching for the media files further comprises setting a search range for the media files and searching for the media files within the set search range.

5. The method as claimed in claim 3, wherein the searching for the media files further comprises automatically setting by the media file management program a search range wherein the media files are searched for.

6. The method as claimed in claim 1 or 2, wherein in the creating the file directories, the file directories are created based on criteria set by a user and metadata corresponding to the criteria.

7. The method as claimed in claim 6, wherein the creating the file directories comprises editing a configuration of the file directories according to a selection of the user.

8. The method as claimed in claim 1 or 2, wherein in the creating the file directories, a file directory is created according to criteria set by a user and subdirectories are created by automatically classifying metadata corresponding to the criteria.

9. The method as claimed in claim 1, further comprising automatically updating the link files after repeating at regular intervals of time, the searching for the media files, the creating file directories, and the creating the link files.

10. The method as claimed in claim 1, further comprising a automatically updating the link files after repeating the searching for the media files, the creating file directories, and the creating the link files when a new media file has been added and/or one of the media files has been deleted.

11. The method as claimed in claim 1, wherein the searching for the media files comprises searching for media files stored in a first storage medium, the creating the file directories comprises creating a file directory in a second storage medium, and the creating link files comprises creating the link files for the media files in the second storage medium.

12. The method as claimed in claim 2, further comprising automatically updating the copied media files after repeating at regular intervals of time, the searching for the media files, the creating file directories, and the copying the media files.

13. The method as claimed in claim 2, further comprising automatically updating the copied media files after repeating the searching for the media files, the creating file directories, and the copying the media files when a new media file has been added and/or one of the media files has been deleted.

14. The method as claimed in claim 2, wherein the searching for the media files comprises searching for media files stored in a first storage medium, the creating the file directories comprises creating a file directory in a second storage medium, and the copying the media files comprises copying the media files in the second storage medium.

15. A system for managing a media file database (DB), comprising:
a search means for searching for media files;
a first storage means for storing the media files and metadata of the media files;
a control means for creating file directories based on the metadata of the media files;
a creation means for creating link files for the media files in the file directories; and
a display means for displaying the link files and the directories comprising the link files.

16. A system for managing a media file database (DB), comprising:
a search means for searching for media files;
a first storage means for storing the media files and metadata of the media files;
a control means for creating file directories based on the metadata of the media files;
a copy means for copying the media files in the file directories to output copied media files; and
a display means for displaying the copied media files and the directories comprising the copied media files.

17. The system as claimed in claim 15 or 16, wherein the search means searches for the media files by executing a media file management program.

18. The system as claimed in claim 17, wherein the search means designates a search range for searching for the media files and then searches for the media files based on the search range.

19. The system as claimed in claim 17, wherein the search means searches for the media files within a search range automatically set by the media file management program.

20. The system as claimed in claim 15 or 16, wherein the control means is operated to create the file directories based on criteria set by a user and metadata corresponding to the criteria.

21. The system as claimed in claim 20, wherein the control means edits a configuration of the file directories according to a selection of the user.

22. The system as claimed in claim 15 or 16, wherein the control means creates file directories according to criteria set by a user and subdirectories are created by automatically classifying metadata corresponding to the criteria.

23. The system as claimed in claim 15 or 16, further comprising a update means for automatically updating the media file database at regular intervals of time.

24. The system as claimed in claim 15 or 16, further comprising an update means for updating the media file database whenever a new media file is added and/or one of the media files is deleted.

25. The system as claimed in claim 15, wherein the control means creates the file directories in a second storage means, and the creation means creates the linked files in the second storage means.

26. The system as claimed in claim 16, wherein the control means creates the file directories in a second storage means, and the copy means outputs copied media files in the second storage means.

27. The method as claimed in claim 1 or 2, wherein the media file DB is managed and played through WINDOWS EXPLORER.

28. The system as claimed in claim 15 or 16, wherein the media file DB is managed and played through WINDOWS EXPLORER.
